(19) United States
(12) Patent Application Publication
(10) Pub. No.: US 2007/0005904 A1
(43) Pub. Date: Jan. 4, 2007

(54) Read ahead method for data retrieval and computer system

(75) Inventors: Damien Lemoal, Sagamihara (JP); Mika Mizutani, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/325,024

(22) Filed: Jan. 3, 2006

(30) Foreign Application Priority Data
Jun. 29, 2005 (JP) 2005-189159

(51) Int. Cl. G06F 13/00

(52) U.S. Cl. 711/137

(57) ABSTRACT

Execution of the read-ahead function to fragmented data will result only in caching non-contiguous physical blocks, failing to hit and wasting any read-ahead data. Even if file accesses are sequential, but if intervals between accesses are too long, it may occur that any cached data are discharged from the buffer memory due to another readout operation with any cached data ending up in vain. Information concerning fragmented locations is taken out from the input-output circuit and included in the management data of the file system. Predefined management data is added to the readout command of the interface. This management data is used to determine whether or not read-ahead should be activated, the amount of data to be read ahead, and other controls for read-ahead processing. With reference to random access or time-based access to the files, the application is to designate whether or not the read-ahead function should be used so as to enable the storage unit to carry out efficient accesses.

### CLAIM OF PRIORITY

The present application claims priority from Japanese application P2005-189159 filed on Jun. 29, 2005, the content of which is hereby incorporated by reference into this application.

### FIELD OF THE INVENTION

This invention relates to a read-ahead method for a storage unit using a rotary recording media and, in particular, to the read-ahead method used by the input-output control circuit (for example, a hard disk controller) and the interface in a storage unit.

### BACKGROUND OF THE INVENTION

The magnetic disk units and, other storage units using rotary recording media are generally equipped internally with the buffer memory that works to make access to data smooth and high-speed between the host computer, and the corresponding storage unit. For example, when data is delivered from the storage unit to the host computer (readout operation), the data is first transferred from the storage space of the storage unit to the internal buffer memory and then passed along to the host computer. The above-mentioned method, as compared to the conventional method wherein access to the storage unit is made by the byte, has greatly improved the access rate of the storage unit. The use of the buffer memory has realized data caching to speed up access to the data that are used very frequently. Such data caching that enables improving the readout operation in quality can be taken as a kind of data read-ahead function.

The data read-ahead function is activated by the readout command which the host computer gives to the storage unit, within which the function is accomplished when the data immediately following the data required by the readout command has been cached in the buffer memory of the storage unit. If the required data is available in the buffer memory of the storage unit (that is, if there is a cache hit), the host computer can save the overhead as may otherwise be spent in the seek in the storage space (rotary recording media) of the storage unit and in the data transfer from the rotary recording media to the buffer memory of the storage unit. If this is the case, an access in a small unit of a few kilo-bytes from the host computer to the storage unit will allow the storage unit to behave as if the access were in a large unit of a few hundred kilo-bytes.

The data read-ahead method provides a great benefit also to the operating system that uses memory paging to operate the virtual storage.

In fact, the physical memory pages that constitute a virtual buffer memory used to receive data from the storage unit may not always be contiguous in the physical memory. For this reason, the operation of reading out data from the rotary recording media to the storage unit may need to be partitioned into a few smaller operations (so as to correspond with each physical page of the virtual buffer memory).

In case the data read-ahead function is enabled in a storage unit performing the above-mentioned access operations, such partitioned operations can process data as fast as a non-partitioned operation can process an even larger size of data.

Dealing not only with a virtual storage but also with sequential access to files can gain a great benefit from read-ahead of data. It is often possible that accessing files in sequential manner with a small chunk of data can achieve the same integrated access rate as accessing the same files in normal manner with a large block of data.

In most cases, the data read-ahead function enhances the access performance of the storage unit, but sometimes it ends up as additional overhead. One example of the latter case is when logically contiguous data is not physically contiguous on the rotary recording media. In other words, this is the case that files are placed on the media in a fragmentary fashion.

The file system manages the files in the storage unit by logically partitioning the storage space of the storage unit into blocks. These blocks are allocated to files in storing data. Accordingly, even though the file is logically a contiguous data storage space, it also occurs sometimes that the input-output control circuit allocates such storage space to noncontiguous physical blocks on the recording media.

Therefore, when making a search for fragmented data on the recording media, the storage unit is compelled to perform I/O operations over a number of noncontiguous physical blocks. The read-ahead function, if applied to fragmented data, caches only a physical block not subsequent to the preceding data, resulting in a no-hit, hence useless, operation. Any sequential access to a file following this file cannot expect a hit at all.

Another problem for which the read-ahead operation ends up in vain occurs when access is made to a file based on the time data. Even if access to a file is made sequentially, but if the time interval between two readout operations in a file is long, it is possible that the read-ahead data may become useless because the cached data may be removed from the buffer memory owing to any other readout operation in other files. Further, if the access to a file is not sequential, it is also possible that the read-ahead processing in the storage unit may become useless because the cached data may be removed from the buffer memory.

The input-output control circuit or the interface of the conventional storage unit normally can only define validity or invalidity of read-ahead function and also amount of read-ahead data for each readout operation (composed of a plurality of readout commands), but it has not been able to define details of read-ahead function for each readout command.

Therefore, in the case that read-ahead conditions exist in mixed state like plural streams being recorded and reproduced, a more specific example of the case being the execution of a video processing application which searches video data in the storage unit at a video-data rate and, at the same time, uses the database for management of the data on the video content kept in storage, the read-ahead function can improve access to the database; with respect to video search in the storage unit under high load, however, the read-ahead function may possibly result almost futile.

With reference to a file management device having a buffer to store files read out of a storage unit by the page, the publicized technique comprising the read-ahead control table to store the data of the page group to be read out simultaneously out of at least a part of pages in the file and the read-ahead control means to perform read-ahead control by the page group above-mentioned on the basis of the content of the read-ahead control table, is referred to in Patent Document 1, Japanese published unexamined patent application No. H8-63378.

A large table is required for a large file. Also, a certain lapse of time between read/write commands makes the read-ahead function useless.

A data processing technique that can conduct the read-ahead processing efficiently by reducing the total number of read commands for read-ahead is publicized as shown in Patent Document 2, Japanese published unexamined patent application No. 2003-84921. However, the effect of the read-ahead function is not enough in the case that, as mentioned above, read-ahead conditions exist in mixed state like plural streams being recorded and reproduced.

Problems to be solved by the present invention are as follows.
1) The read-ahead function, if executed to the data in fragmented physical blocks, will cache a non-contiguous physical block only to prove that gaining no hit, read-ahead operation ends up in vain.
2) Even if file access is made sequentially, but if the time interval between such two sequential readout operations is too long, it is possible that the read-ahead data may become useless because the cached data may be removed from the buffer memory owing to any other readout operation in the file.

### SUMMARY OF THE INVENTION

The data concerning the location of fragmented physical blocks is taken out from the input-output control circuit of the storage unit and included in the management information (meta-data) of the file system.

Predetermined management information is added to the readout command of the interface. This management information is used to determine whether or not to process the read-ahead function together with the readout command, define the amount of data to be read ahead, and control other aspects of the read-ahead method.

Depending on the contiguousness of the physical blocks in the storage unit and also according to the pattern of access by application to the logical data blocks of the file, the storage unit can control the read-ahead function positively.

If the management information of the file system can be detected, it is easy to detect that the read-ahead operation will be wasted, since the access is to a fragmented non-contiguous physical block.

The application that handles files can specify so that the storage unit may choose the most efficient way of access (that is, whether the read-ahead function be used or not) with respect to random or time-based access to files.

The use of the readout command in the present invention, unlike the mechanical read-ahead function controlled by the conventional readout command processing, makes it possible to eliminate useless read-ahead processing stemming from the access to non-contiguous physical blocks, thereby reducing the load on the storage unit.

By decreasing useless read-ahead operations as mentioned above, it also becomes possible to do without expanding storage area in the buffer memory of the storage unit every time the read-ahead function is used to process the readout commands. Therefore, the rate of cache hit can be improved in the data search in the buffer memory carried out while processing of other readout commands is going on.

The files to which access is made at random or on time base can be accessed without the use of the read-ahead function, and therefore, they do not affect the hit rate of other file accesses in the buffer memory of the storage unit.

The read-ahead method in the present invention is effective in reducing the load that the data readout causes on the storage unit and also in enhancing data access rate when the load is heavy or when there is some limitation in data access time.

### BRIEF DESCRIPTION OF THE DRAWINGS

Embodiments of the present invention will be described in detail based on the following figures, wherein:

FIG. 1 is an illustration of an example of application of the present invention;

FIG. 2 is a schematic diagram showing a typical hardware configuration of a host computer that manages a storage unit using a file system program and executes applications using the file system;

FIG. 3 is an illustration to explain management of a file system with respect to storage area of a storage unit;

FIG. 4 is an illustration showing the data structure of a file system used for management of files stored in a storage unit;

FIG. 5 is a schematic diagram to explain operations of reading out data stored in the storage unit by use of the present invention;

FIG. 6 is an illustration showing an example of format of readout command of the present invention;

FIG. 7 is a flow chart illustrating the process by which applications perform search and readout of the data stored in the storage unit;

FIG. 8 is an illustration to explain that the data cached in a buffer memory used in a storage unit are indexed for management; and

FIG. 9 is a flow chart illustrating the flow of processing of readout command in a storage unit;

### DESCRIPTION OF THE EMBODIMENTS

The embodiments of the present invention are explained in the following.

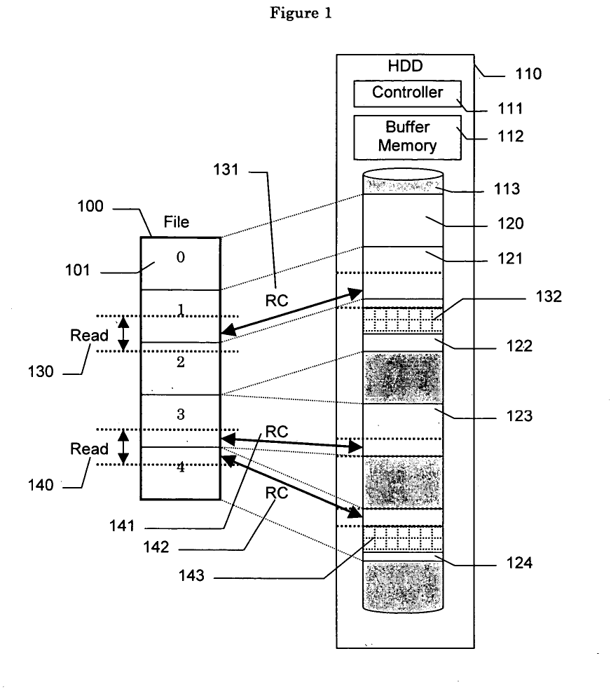

FIG. 1 shows an example of application of the present invention.

A file 100 stored in a hard disk drive 110 is accessed from a host computer in logical sequence. The file shown in this example consists of five logical data blocks expressed with the numbers from 0 (101) to 4. The data corresponding to these logical data blocks are mapped in the physical storage space, from a block 120 to a block 124, of a disk 113. On the file 100, two readout operations 130 and 140 are indicated.

The readout operation 130 spans two logical data blocks (block 1 and block 2), and also, these logical data blocks are mapped in two contiguous physical blocks 121 and 122. At this point, the host computer, upon request from the application, gives the controller 111 instruction to read the logical data blocks 1 and 2, and the controller 111 processes the instruction using the readout command 131, the only command that can read the corresponding physical blocks 121 and 122 on the “read-ahead function valid” condition. This command 131 (a readout command with the read-ahead function) activates the read-ahead function for the data in the data zone 132 of the block 122, and it also activates the operation to input the data into the buffer memory 112 of the hard disk. In this way, other readout operations subsequent to the readout operation 130 can be processed more quickly in the hard disk drive.

In contrast to the above, the readout operation 140 spans over the two logical data blocks (the block 3 and the block 4), which are mapped in the two non-contiguous physical blocks 123 and 124. At this point, the host computer, upon request from the application, gives the controller 111 instruction to read the logical data blocks 3 and 4, and the controller 111 read the corresponding physical blocks 123 and 124 specifying the use of the read-ahead function. Processing is thus made by using the readout command 141 and 142 respectively.

In these readout operations, the two readout commands, 141 and 142, are given to the controller 111. As it is known from the management information of the file system that the physical block 123 is fragmented, the controller 111 nullifies the effect of the read-ahead function to the command 141. But to the command 142, the controller 111 makes the read-ahead function valid and activates the operation to store the data of the memory zone 143 of the block 124 into the buffer memory 112 of the hard disk.

By making the read-ahead function of the physical data either valid or invalid properly corresponding to the logical data blocks of the file data, useless read-ahead can be eliminated without affecting the performance of sequential access to the files. While improving the hit rate of the pre-fetched data in the buffer memory of the storage unit, it is possible to reduce the amount of data searched in the storage area of the storage unit and further to enhance the data access performance of the storage unit.

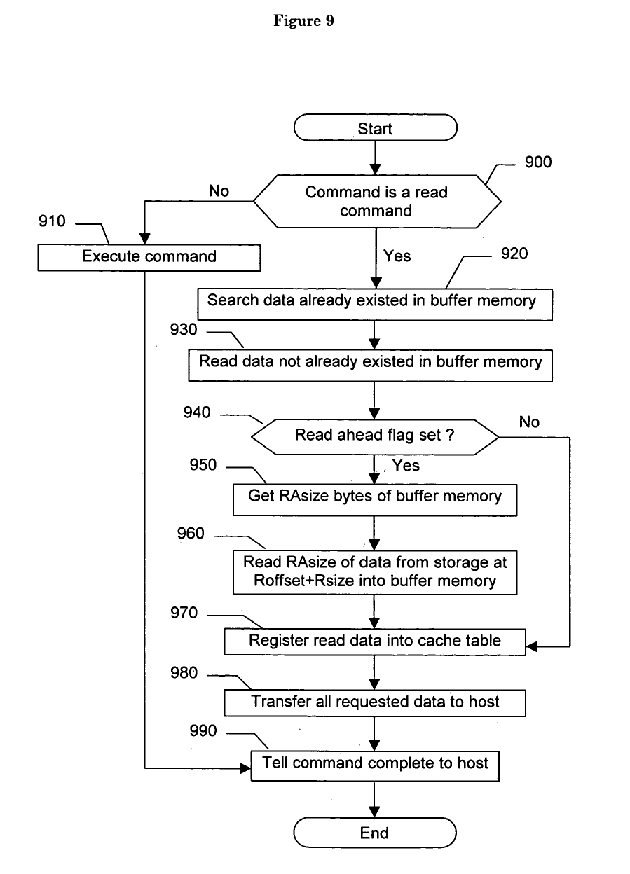

Though not, shown in FIG. 1, the data read out from the magnetic disk media in the above-mentioned manner are to be stored accordingly in the buffer memory 112 (FIG. 9) owing to the cache function of the buffer memory 112, as described later in more detail.

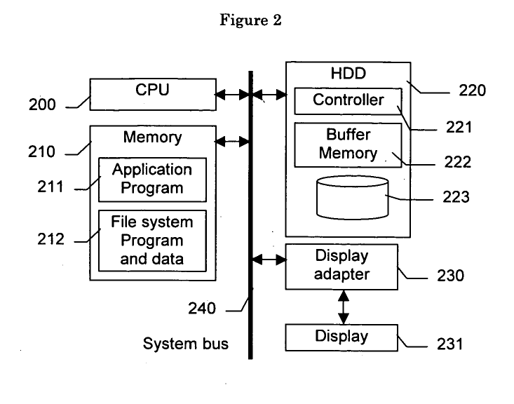

Now, with reference to the computer system in FIG. 2, the read-ahead function of the storage unit is explained below.

The read-ahead method of the present invention is applied to the HDD (hard disk drive) system 220 to which commands are delivered from the CPU (central processing unit) 200 through the system bus 240. The HDD system 220 has the configuration that the controller 221 controls the access to the data stored in the magnetic disk media 223 by means of the buffer memory 222.

The issuance of commands to the HDD 220 is carried out by executing the application 211 on the CPU 200 using the file system 212 in the main memory 210 of the system. The display 231 used through the display adapter 230 exhibits the results of data processing. According to the hints delivered by the application 211 and further to the contiguousness of the physical blocks on the magnetic disk media 223 corresponding to the data of the files, the file system 212 sets the read-ahead function through the readout command every time the readout command is delivered to the HDD 220.

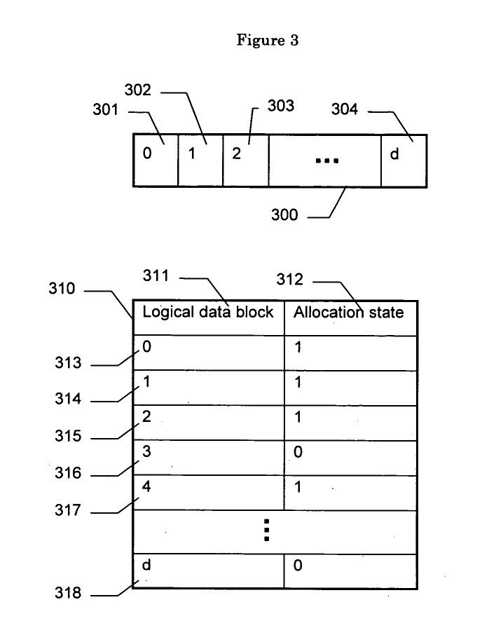

FIG. 3 is a block allocation table showing an example of the storage space 300.

The program of the file system 212 manages the storage space 300 of the hard disk drive 220 by dividing it into logical data blocks 301, 302, 303, . . . , 304, each being a logical data block of the contiguous disk storage space and having a certain fixed size. Each logical data block is identified with the logical data block number from “0” (301) to “d” (304). This makes it possible to easily create direct mapping between the physical block numbers and the logical data block numbers on the magnetic disk media 223.

The file system 212 uses the table 310 to control the allocation state 312 of each logical data block 311 in relation to the magnetic disk media 223. The state of allocation is indicative of whether or not the logical data blocks are responded to with effective data and also the same blocks are currently in use. FIG. 3 shows the blocks “0” (313), “1” (314), “2” (315), and “4” (317) are being used. These logical data blocks are allocated for storing the file system data. The blocks “3” (316) and “d” (318) are not in use. The storage space 300 itself is preserved in the magnetic disk media 223 by means of one or plural physical blocks, and even if there is a power failure to the system, it can be sustained as in the state shown in FIG. 3. It may be deployed, if necessary, to the memory 210.

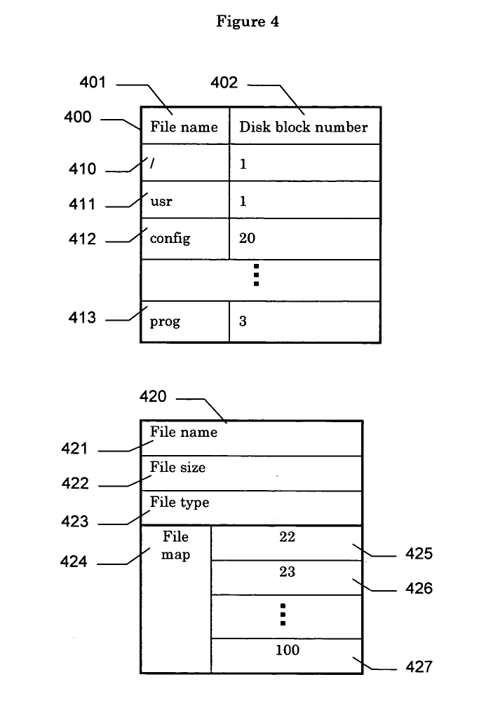

FIG. 4 shows a table to control the files handled by the file system.

The file table 400 keeps record of the physical block (disk block) number 402 containing the file management information identified by the file name 401. The file table 401 itself is stored in the magnetic disk media 223. The file table 400 may be deployed, if necessary, to the memory 210.

The descriptor for each file 420 is used to retain the file name 421, file size 422, file type 423, and other data of a file. The data of the file descriptor also includes the file map 424. The file map 424 is a table of numbers of physical blocks, which are used to store file data.

Each entry in the file table 400 is indicative of the file block logically adjoining the preceding block (101 in FIG. 1). Accordingly, the entry number 401 is called a file logical data block.

The file map 424 serves to make coordination between the logical data blocks dealt by the files and the physical blocks on the magnetic disk media. This simplifies conversion of the file offset (the offset of the logical address) to the physical address.

For example, the data of “offset 0” in this file 420 is in the logical data block “0” which is mapped onto the physical block 22 (425), and the offset data equal in size to this physical block is in the logical data block “1,” which is mapped onto the physical block number 23 (426) in the magnetic disk media. Furthermore, the last octet of the data of this file is mapped onto the physical block 100 (427) on the disk and is in the logical data block of the file map 424.

Because of such data structure being in coordinative relationship, simplified mapping between the logical address (the data offset in the file 420) of the file system data and the physical address has become possible.

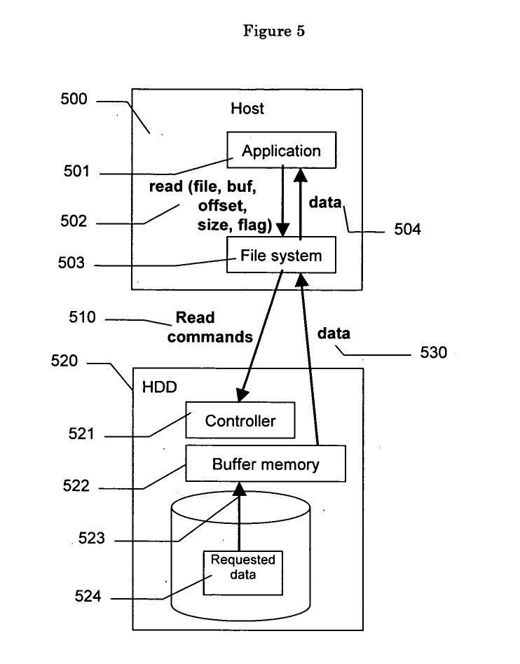

With reference to FIG. 5, the data readout operation in this invention is explained as follows.

When request for the data stored in the magnetic disk device 520 is made from the application 501 to the file system 503 on the host computer 500, the readout function 502 designates a number of flags concerning the files to be read out from, amount of readout data, address of the first byte of the readout data, address of the buffer memory to be used by the application to receive the readout data, and whether or not readout operation be made with the read-ahead function on.

As a result, two main types of readout operations are made available; namely, one is the readout operation “without read-ahead” when the flag “no read-ahead” is designated, and the other is the readout operation “with read-ahead” when no flag is designated (default option).

The file system 503 processes the read operation by sending one or plural read commands 510 to the controller 521. The controller 521 searches (523) for the requested data 524 stored on the magnetic disk media and store that data in the buffer memory 522. At the same time, the physical block number and the physical address of the requested data 524, both corresponding to the file descriptor, are also stored in the buffer memory 522 as pertinent data for the data 524.

The searched data 530 and other data are transferred from the buffer memory 522 to the file system 503 of the host computer and delivered (504) to the application 501.

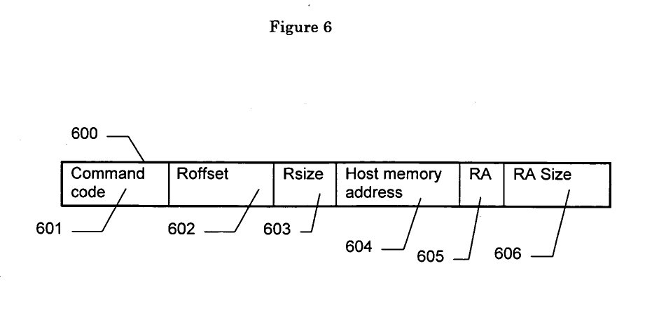

FIG. 6 shows the format of the readout command 510, which the file system 503 (FIG. 5) sends to the controller 521 of the HDD 520.

The readout command 600 is inclusive of the command code 601 used to identify the readout command from other commands. Subsequently to this command code 601 follow the physical address 602 (Roffset) of the data to be read out and the amount of data 603 (Rsize) to be read out from that address. The readout data needs to be returned to the address 604 specified by the host memory. Also the flag 605 is added to designate whether or not the readout command should activate the read-ahead processing (RA). When the RA flag is set, or in other words, when the read-ahead function is put into effect, the maximum amount of data to be read-ahead is designated by the readout command by means of RAsize 606.

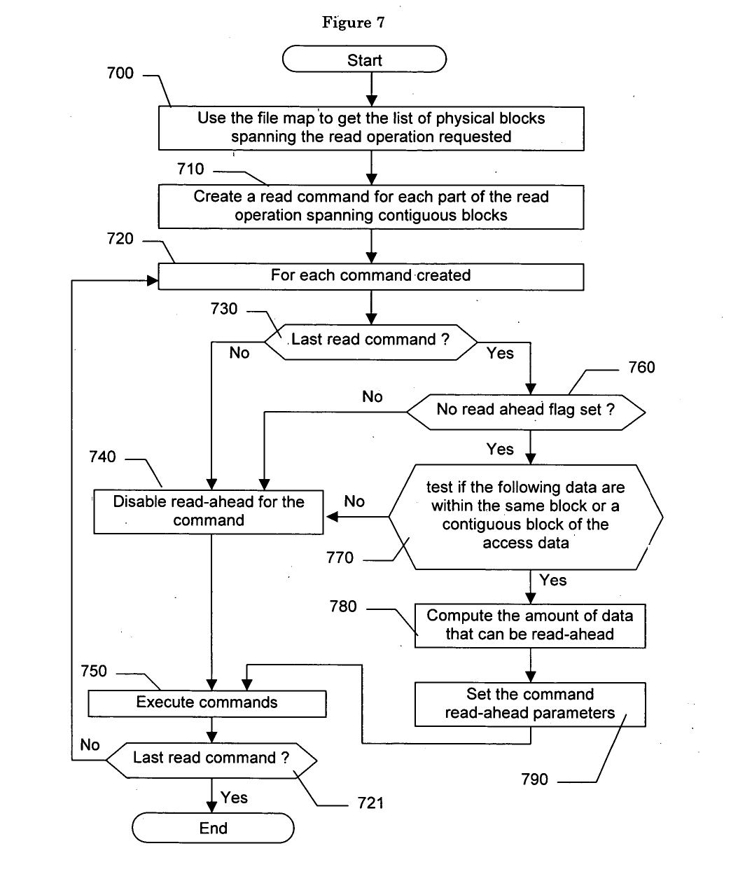

FIG. 7 is used to explain the process that the application, by way of the file system, sends the readout command to the controller of the HDD so that the data readout may be completed.

The file system makes use of the file map (424 in FIG. 4) to obtain the list of the physical blocks which keep the requested data for readout operation (700). The file map is created by the file system based on the data that the input-output control circuit of the storage unit conveys to the file system directly or via the buffer memory.

Secondly, search is made of this list to create readout commands for the entire segment (set of physical blocks) of the readout operation spanning contiguous logical data blocks. (See the readout operation 140 in FIG. 1 for an example of segment.)

Then, all of the commands thus created are to be processed one by one as follows. In case the readout command to be processed is other than the last one of those readout commands created, the read-ahead function cannot be requested because the readout commands are set to get access to the data of a plural set of contiguous physical blocks. Accordingly, the read-ahead flag should be disabled (740) to execute the readout commands (750).

In case the last readout command is created, check is made of the flag (760) specified by the readout operation (the readout function 502 shown in FIG. 5). If the application specifies the “readout operation without read-ahead,” the read-ahead flag of this command should be disabled (740) to execute the readout commands.

Contrary to the foregoing, if this application does not specify the “readout operation without read-ahead” (default option), the read-ahead flag is set with the command. In this case, check is to be made of the mapping of the physical data corresponding to the data of the file subsequent to the data to which the command makes access (770).

If there is no following data existing in the physical block adjoining the last physical block to which the readout command makes access, the read-ahead flag should be disabled to execute the readout command. If the case is otherwise, the amount of data that can be read-ahead should be computed (780) as the amount of data of the file adjoining the data to be accessed. This computed value is set in the RAsize field of the readout command to execute the readout commands (750). This processing is finished when the last readout command created has been executed (721).

In the above manner, it is assured that the read-ahead function is to be disabled for processing of the readout commands for which read-ahead is of no use. As a measure against a large amount of fragmented physical blocks disposed corresponding to the logical data blocks of the non-contiguous files on the magnetic disk media, the read-ahead function is so arranged as to be applicable only to the data following the accessed data, thereby also enabling speed-up of subsequent accesses. This read-ahead function is valid as default (in case the application does not require the readout operation “without read-ahead”).

This readout operation enables random file access without imposing load on the HDD. It is effective for accessing a very large file involving limited access time (e.g., a video animation file).

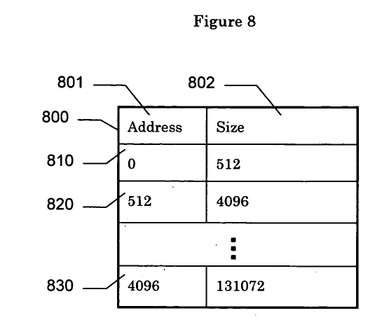

FIG. 8 is used to explain the management of the data cached in the buffer memory of the HDD.

The controller of the hard disk maintains, on the magnetic disk media, the cache table 800 of the data zone cached in the buffer memory of the HDD. This table 800 identifies each data zone using the physical address 801 for the first byte of the data in the data zone and the size 802 of the data zone.

For example, not only the data zones 512/4096 (820) and 4096/131072 (830) but also the data zone (810) identified by the address that starts from “0” and the size 512 bytes are cached in the buffer memory.

FIG. 9 shows the processing flow of the readout command in the HDD.

The cache table 800 (FIG. 8) is used in the controller of the HDD, while the readout command is being processed as follows. Firstly, the code of the received command is checked if it is a readout command (900). If the command is not a readout command, it is to be executed (910), and the ending of the command is notified to the host computer (990).

If it is a readout command, the requested data which is already cached in the buffer memory is to be searched (920) by utilizing the cache table 800 in the controller of the HDD. Only the data not cached yet is searched in the HDD (930). At this step, a part of entries in the cache table that has nothing to do with the current command may have to be released to get enough space in the buffer memory to cache the searched data.

Secondly, the command is checked to see if it is set with the read-ahead flag (940). If read-ahead is not required for the current command, the searched data is to be registered in the cache table (970), and in the host computer, all of the requested data (searched data and cached data) are to be transferred to the memory address as specified in the readout command (980).

In case the readout command requires read-ahead, it is the time then to set the RA flag with the readout command. First, additional storage area should be secured in the buffer memory (950), and the data searched by read-ahead are to be cached therein. The size of such storage area should be at least equal to the amount of the read-ahead data (RAsize field) specified in the readout command.

Then, in the HDD, the data on the amount of the read-ahead data are to be searched at the address as specified in the “Roffset field+Rsize field” (960). Further, the cache table of the controller of the hard disk is changed so as to register caching of the read-ahead data (970), and in the same way as the readout command without read-ahead, the readout command is to be finished. That is to say, the data is transferred to the host computer (980), and the ending of the command is notified to the host computer (990).

The read-ahead method in the present invention can be used for the manufacture of a magnetic disk device that, in parallel with recording and playing visual data, particularly animation data, can execute another access at high speed, low noise, and low power consumption.

Having described a preferred embodiment of the invention with reference to the accompanying drawings, it is to be understood that the invention is not limited to the embodiments and that various changes and modifications could be effected therein by one skilled in the art without departing from the spirit or scope of the invention as defined in the appended claims.

What is claimed is:

1. A computer system having a central processing unit (CPU), a storage unit using memory and rotary recording media with connection so made as to be accessible to the CPU, and the read-ahead function used when to read out the file data written in the rotary recording media via the CPU by means of the file system deployed on the memory, wherein:
the file system comprises:
the function to keep information concerning the location where the data are fragmented on the rotary recording media and
the read-ahead function performed by a part of readout commands out of one or a plurality of readout commands to read out the data on the rotary recording media, the data corresponding to a part of the data of the file.

2. The computer system according to claim 1, wherein:
a part of one or a plurality of readout commands as aforesaid performs readout from the buffer memory of the storage unit.

3. The computer system according to claim 1, wherein:
the information concerning the location of fragmentation can be obtained by maintaining contiguous physical blocks, and a part of readout commands as aforesaid are the same as the readout commands used when to read out respectively the last physical block of the contiguous physical blocks if the contiguous physical blocks are made the target, or the last physical block of the non-contiguous physical blocks if the non-contiguous physical blocks are made the target.

4. A computer system having a central processing unit (CPU), a storage unit using memory and rotary recording media with connection so made as to, be accessible to the CPU, and the read-ahead function used when to read out the file data written in the rotary recording media via the CPU by means of the file system deployed on the memory, wherein:
the file system comprises:
the function to keep the information concerning the physical block where the data are fragmented on the rotary recording media and:
the function that one of the readout commands to read out data from a plurality of contiguous physical blocks on the rotary recording media, the data corresponding to a part of the data of the file, performs read-ahead with only the last physical block out of a plurality of contiguous physical blocks as aforesaid.

5. A computer system having a central processing unit (CPU), a storage unit using memory and rotary recording media with connection so made as to be accessible to the CPU, and the read-ahead function used when to read out the file data written in the rotary recording media via the CPU by means of the file system deployed on the memory, wherein:
the file system comprises:
the function to keep information concerning the physical blocks where the data are fragmented on the rotary recording media and
the read-ahead function performed by a part of readout commands out of a plurality of readout commands to read out the data of a plurality of fragmented physical blocks on the rotary recording media, the data corresponding to a part of the data of the file.

6. The computer system according to claim 4, wherein:
a part of one or a plurality of readout commands as aforesaid performs readout from the buffer memory of the storage unit.

7. The computer system according to claim 5, wherein:
a part of one or a plurality of readout commands as aforesaid performs readout from the buffer memory of the storage unit.

8. The computer system according to claim 5, wherein:
a part of the readout commands as aforesaid are the same as the readout commands used when to read out the data of one fragmented physical block as aforesaid.

9. The read-ahead method applied to the data written to the rotary recording media in a computer system having a central processing unit (CPU), and a storage unit using memory and rotary recording media with connection so made as to be accessible to the CPU, comprising the following steps:
(1) firstly that the file system deployed on the memory writes the file data to the physical block on the rotary recording media via the CPU,
(2) secondly that the storage unit conveys the file system the information concerning location of the data written to the physical block,
(3) thirdly that the file system is required to read out the data in the file,
(4) fourthly that the file system, when creating a readout command for plural contiguous physical blocks corresponding to a part of the file for which readout is required, specifies one readout command that is to read-ahead only the last block; and the file system, when creating readout commands for plural non-contiguous physical blocks corresponding to a part of the file for which readout is required, specifies plural readout commands that are to read-ahead only the last block; and
(5) fifthly that the readout commands created by the file system are executed.

10. The data read-ahead method according to claim 9, wherein:
a part of one or a plurality of readout commands as aforesaid performs readout from the buffer memory of the storage unit.
